(19) United States
(12) Patent Application Publication
(10) Pub. No.: US 2008/0140908 A1
(43) Pub. Date: Jun. 12, 2008

(54) STORAGE SYSTEM, AND METHOD AND PROGRAM FOR SELECTING MEMORY REGION

(76) Inventor: Michitaro Miyata, Tokyo (JP)

Correspondence Address: NEC CORPORATION OF AMERICA, 6535 N. STATE HWY 161, IRVING, TX, 75039, US

(21) Appl. No.: 11/950,040

(22) Filed: Dec. 4, 2007

(30) Foreign Application Priority Data
Dec. 6, 2006 (JP) 2006-329385

(51) Int. Cl. G06F 12/00

(52) U.S. Cl. 711/100; 711/E12.001

(57) ABSTRACT

A storage system includes a command collecting unit 40 that collects a command for a memory region targeted for transfer and extracts an access pattern from the collected command, a test command issuing unit 41 that issues a test command to a transfer destination candidate memory region using the extracted access pattern, and a response time measuring unit 42 that measures a response time to the test command. The storage system can prevent occurrence of a situation where desired performance for an actual access pattern cannot be fulfilled after data transfer has been completed.

### REFERENCE TO RELATED APPLICATION

This application is based upon and claims the benefit of the priority of Japanese patent application No. 2006-329385, filed on Dec. 6, 2006, the disclosure of which is incorporated herein in its entirety by reference thereto.

### FIELD OF THE INVENTION

The present invention relates to a storage system technology. More specifically, the invention relates to a system, a method, and a computer program, suitable for being applied to a storage system in which at least one memory region is selected from a plurality of memory regions.

### BACKGROUND OF THE INVENTION

In storage systems, in order to perform load distribution inside a same storage device and efficiently utilize a memory, a technology for transferring data to a different region and rearranging the transferred data in different regions has been known up to now. Further, among a plurality of storage devices as well, in order to perform load distribution between the storage devices or replace a storage device by a new storage device, a technology for transferring and rearranging data has been known.

Patent Document 1, for example, discloses a technology for rearranging data between a plurality of memories having different attributes, according to usage states of the memories arranged inside a storage device.

Patent Document 2 discloses a technology for rearranging data between a plurality of storage devices having different processing performances.

[Patent Document 1]
JP Patent No. 3541744

[Patent Document 2]
JP Patent Kokai Publication No. JP-P2005-276017A

### SUMMARY OF THE DISCLOSURE

The following analyses are given by the present invention. The entire disclosures of Patent Documents 1 and 2 are incorporated herein by reference thereto.

When data transfer for rearrangement is performed, it is necessary to select a memory region which becomes a transfer destination from among a plurality of storage devices or a plurality of memory regions inside a same storage device.

In this case, a vacant capacity, a level of RAID (Redundant Arrays of Independent Disks), or performance is used for a determination criterion for the selection.

Among these criteria, the vacant capacity and the RAID level can be readily known from static information possessed by the storage device.

The performance, however, depends on various complex factors such as an access pattern from a host, an internal configuration of the storage device, a processing method of the storage device, and a memory region usage state. Thus, the performance cannot be readily predicted.

For this reason, unless data transfer is actually performed, it cannot be known whether desired performance can be exhibited at the transfer destination.

Further, when there are a plurality of candidates for the transfer destination, it is difficult to assess which candidate for the transfer destination should be selected to obtain a performance most close to the desired performance. In an environment where many different kinds of storages are connected, in particular, this problem is manifest. As described above, a conventional system has problems that will be described below.

A first problem is that it is difficult to predict whether a desired performance is exhibited or not at the transfer destination until the data transfer has been actually completed. The reason therefor is because the performance depends on the various complex factors.

A second problem is that it is difficult to assess which transfer destination should be selected to obtain a performance close to the most desired performance when there are a plurality of storage devices or a plurality of memory regions that become candidates for the transfer destination. The reason is because the performance differs depending on an internal configuration, a processing method, and a usage state of the storage device that will become the transfer destination, simple performance comparison is difficult.

It is an object of the present invention to provide a storage system, a computer program, and a method capable of selecting a memory region that can exhibit desired performance for an actual access after switching-over to a memory region has been performed, on the occasion of memory region switching-over.

It is other object of the present invention to provide a storage system, a computer program, and a method capable of selecting from among a plurality of different kinds of storages or a plurality of memory regions a storage device or a memory region having appropriate performance as a destination of transfer.

According to certain aspects, the present invention is generally configured as follows.

According to a first aspect of the present invention, there is provided a storage system comprising:

a plurality of memory regions;

a command collecting unit that collects a command (or commands) to be received by at least one of the memory regions and extracts access information of the command(s) from the collected command(s);

a test command issuing unit that issues a test command (or commands) to any other ones of the memory regions than the at least one of the memory regions with the command(s) thereto collected by the command collecting unit, the test command(s) having the extracted access information as contents thereof; and

a response time measuring unit that measures a response time to the test command(s) issued from the test command issuing unit to any other ones of said memory regions.

According to a second aspect of the present invention, there is provided a storage system comprising:

first and second storage devices each including at least one memory region;

the first storage device including:

a command collecting unit that collects a command (or commands) to be received by the at least one memory region of the first storage device and extracts access information of the command from the collected command;

the second storage device including:

a test command issuing unit that receives the access information extracted by the command collecting unit of the first storage device and issues a test command (or commands) having the access information as contents thereof; and

a response time measuring unit that measures a response time to the test command(s) issued from the test command issuing unit to the at least one memory region of the second storage device.

The storage system may include at least one storage device having the memory regions; and

the test command issuing unit may be provided externally of the at least one storage device.

The storage system may include at least one storage device having the memory regions; and

the test command issuing unit and the response time measuring unit may be provided outside the at least one storage device.

The storage system may include a host that issues a command to any ones of the memory regions; and

the host may include the command collecting unit.

The storage system may include:

a storage device(s) having the memory regions;

a host that issues the command to any of the memory regions; and

a communication path(s) that connects the storage device(s) and the host;

the command collecting unit being disposed on the communication path.

The storage system may include: at least one storage device having the memory regions; the at least one storage device including: the command collecting unit; the test command issuing unit; and the response time measuring unit.

The storage system may include a determination unit that determines one of the memory regions of a switching-over destination, based on results of measurement of the response times to the test command. The determination unit may sum up response times responsive to a plurality of the test commands measured by the response time measuring unit and may determine one of the memory regions based on the sum of the response times satisfying a predetermined condition, as the memory region of the switching-over destination. The determination unit may sum up the response times to the test commands measured by the response time measuring unit and may determine one of the memory regions based on a minimum of the sum of the response times as the memory region of the switching-over destination.

The access information may include a command text (instruction), an address in the at least one of the memory regions, and a transfer length, contained in the command.

The storage system may include: a storage device including the memory regions; a host that issues the command to each of the memory regions of the storage device; and a server that communicates with the storage device and the host. The host may include the command collecting unit, and the server may include the test command issuing unit and the response time measuring unit.

According to a third aspect of the present invention, a storage system may include:

a plurality of memory regions;

means for issuing a test command (or commands) to a candidate memory region based on history information on a data access command already issued to any other one of the memory regions when selecting one of the memory regions used for a data access, the test command(s) reflecting the data access actually made to the other one of the memory regions; and

means for determining the one of the memory regions based on a performance characteristic of the candidate memory region measured in association with execution of the test command(s).

According to a fourth aspect of the present invention, a storage system may include:

a plurality of memory regions;

means for issuing to other ones of the memory regions a test command (or commands) associated with a command (or commands) already issued to any one of the memory regions; and

means for measuring responses to the test command(s) for the other ones of the memory regions and determining one of the memory regions of a switching-over destination, based on results of measurement.

According to a fifth aspect of the present invention, there is provided a method of selecting a memory region in a storage system having a plurality of memory regions, the method comprising:

collecting a command (or commands) to be received by at least one of the memory regions and extracting access information from the collected command;

issuing a test command (or commands) to any other ones of the memory regions than the at least one of the memory regions for which the command(s) thereto has been collected, the test command(s) having the extracted access information as contents thereof;

measuring response times to the test command issued to the other memory regions; and

selecting one memory region from the other memory regions based on results of measurement of the response times.

According to a sixth aspect of the present invention, a method of selecting a memory region comprises: issuing a test command (or commands) to a candidate memory region based on history information on a data access command already issued to an other one of memory regions when selecting one of the memory regions used for a data access, the test command(s) reflecting the data access actually made to the other memory region; and

selecting the one of the memory regions based on a performance characteristic of the candidate memory region measured in association with execution of the test command(s).

According to a seventh aspect of the present invention, there is provided a program that causes a computer to execute processing of selecting a memory region from a storage system including a plurality of memory regions, the processing comprising:

collecting a command (or commands) to be received by at least one of the memory regions and extracting access information from the collected command(s);

issuing a test command (or commands) to any other ones of the memory regions than the at least one of the memory regions with the command(s) thereto collected, the test command(s) having the extracted access information as contents thereof;

measuring response times to the test command(s) issued to the other memory regions; and

selecting one memory region from the other memory regions based on results of measurement of the response times.

According to an eighth aspect of the present invention, there is provided a program that causes a computer to execute processing of:

issuing a test command (or commands) to a candidate memory region based on history information on a data access command (or commands) already issued to any other ones of memory regions when selecting one of the memory regions used for a data access, the test command(s) reflecting the data access actually made to the other ones of the memory regions; and

selecting the one of the memory regions based on a performance characteristic of the candidate memory region measured in association with execution of the test command(s).

The meritorious effects of the present invention are summarized as follows.

The present invention allows selection of a memory region that can exhibit desired performance to an actual access, from among the memory regions. For this reason, according to the present invention, occurrence of a situation where the desired performance cannot be fulfilled for an actual access pattern after completion of data transfer, for example, can be avoided or prevented. The reason therefor is that in the present invention, performance measurement using the actual access pattern is performed in memory regions that become candidates for a switching-over destination before memory region switching-over is performed, and based on results of the measurement, the memory region is selected.

Further, according to the present invention, a storage having appropriate performance can be selected as a transfer destination from among a plurality of different kinds of storages or a plurality of memory regions. The reason therefore is that in the present invention, performance measurement using the actual access pattern is performed in a plurality of environments, and comparison of results of the measurement is performed.

### BRIEF DESCRIPTIONS OF THE DRAWINGS

FIG. 1 is a block diagram showing an example of a system configuration in a first exemplary embodiment of the present invention;

FIG. 2 is a diagram showing an example of the system configuration in the first exemplary embodiment of the present invention;

FIGS. 3A, 3B, and 3C are diagrams each schematically showing examples of memory regions 10 in the first exemplary embodiment of the present invention;

FIG. 4 is a flowchart for explaining operations of the first exemplary embodiment of the present invention;

FIG. 5 is a diagram showing an example of a pattern storage unit in the first exemplary embodiment of the present invention in the form of a table;

FIGS. 6A and 6B are diagrams each showing an example of a response time storage unit in the first exemplary embodiment of the present invention, in the form of tables;

FIGS. 7A and 7B are diagrams showing examples of a response time storage unit in the first exemplary embodiment of the present invention, respectively;

FIG. 8 is a block diagram showing an example of a system configuration in a second exemplary embodiment of the present invention;

FIG. 9 is a diagram showing an example of the system configuration in the second exemplary embodiment of the present invention;

FIGS. 10A, 10B, and 10C are diagrams each schematically showing examples of memory regions 10 in the second exemplary embodiment of the present invention;

FIG. 11 is a flowchart for explaining operations of the second exemplary embodiment of the present invention;

FIG. 12 is a diagram showing an example of a response time storage unit in the second exemplary embodiment of the present invention in the form of a table;

FIG. 13 is a diagram showing an example of a response time storage unit in the second exemplary embodiment of the present invention in the form of a table;

FIG. 14 is a diagram showing an example of the response time storage unit in the second exemplary embodiment of the present invention in the form of a table;

FIG. 15 is a block diagram showing an example of a system configuration in a third exemplary embodiment of the present invention;

FIG. 16 is a diagram showing an example of the system configuration in the third exemplary embodiment of the present invention;

FIGS. 17A, 17B, and 17C are diagrams each schematically showing an example of the memory region 10 in a third exemplary embodiment of the present invention;

FIG. 18 is a flowchart for explaining operations of the third exemplary embodiment of the present invention;

FIG. 19 is a diagram showing an example of a pattern storage unit in the third exemplary embodiment of the present invention, in the form of a table;

FIG. 20 is a diagram showing an example of a response time storage unit in the third exemplary embodiment of the present invention, in the form of a table; and

FIG. 21 is a diagram showing an example of the response time storage unit in the third exemplary embodiment of the present invention, in the form of a table.

### PREFERRED MODES OF THE INVENTION

Next, preferred modes for carrying out the invention will be described in detail with reference to drawings.

### First Exemplary Embodiment

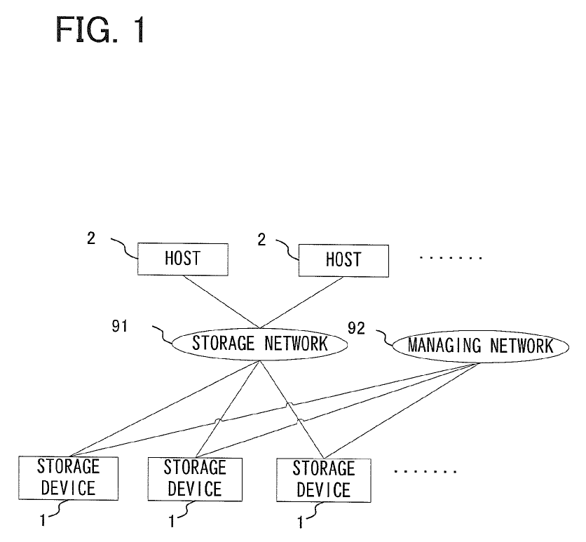

FIG. 1 is a diagram showing an overall system in a first exemplary embodiment of the present invention. Referring to FIG. 1, the first exemplary embodiment of the present invention includes at least one storage device 1, at least one host 2, a storage network 91, and a managing network 92.

The host 2 accesses the storage device 1, thereby performing data writing and reading.

The storage device 1 performs recording of data transmitted from the host 2 and provides recorded data to the host 2, in accordance with a request (a write/read request) from the host 2.

The storage network 91 connects the storage device 1 and the host 2, thereby providing a communication path or paths for transmitting and receiving an access command and data.

The managing network 92 provides a communication path or paths between the different storage devices 1.

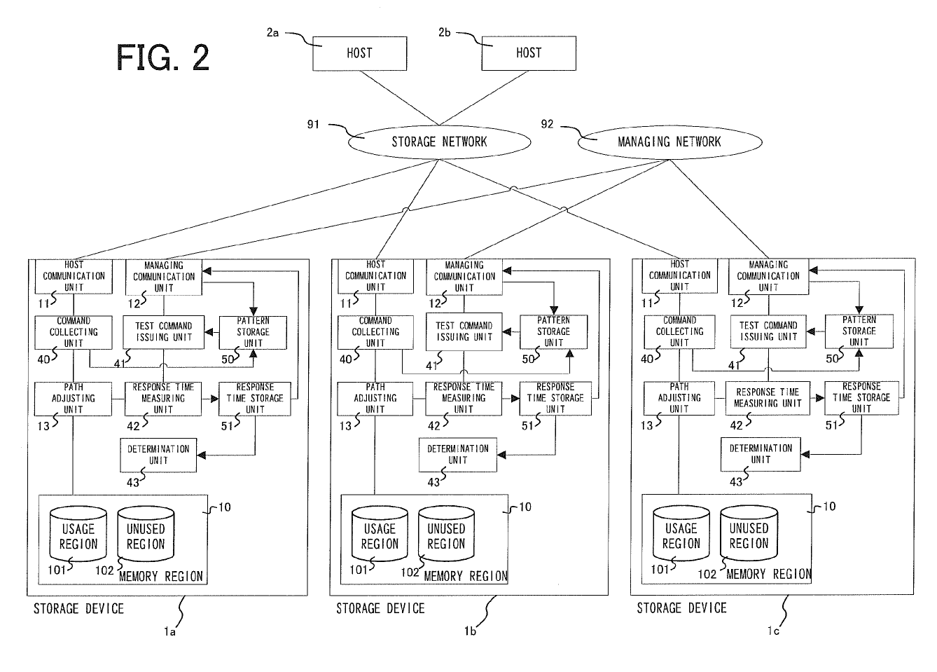

FIG. 2 is a diagram showing an example of a detailed configuration of the system in FIG. 1, and shows a configuration example using three storage devices 1a, 1b, and 1c as the storage devices 1 and using two hosts 2a and 2b as the hosts 2.

Referring to FIG. 2, the storage device 1 in this exemplary embodiment includes a memory region 10, a host communication unit 11, a managing communication unit 12, a path adjusting unit 13, a command collecting unit 40, a test command issuing unit 41, a response time measuring unit 42, a determination unit 43, a pattern storage unit 50, and a response time storage unit 51.

The memory region 10 is a region formed of one or more physical memories each having a physical storage address space (hereinafter referred to as a “physical address space”). The memory region 10 includes a usage region 101 and an unused region 102.

The usage region 101 is a region to which a logical address space (hereinafter referred to as a “logical address space”) is assigned to a part or entirety of the physical address space included by the memory region 10, and is a unit targeted for a Read (reading)/Write (writing) access. It is not always necessary to assign the logical address space to a continuous physical address space. The logical address space may be assigned over physical address spaces of a plurality of hard disks by striping, such as in a RAID 0. Alternatively, a plurality of physical address spaces may be assigned to one logical address space by mirroring, such as in a RAID 1. In an SCSI (Small Computer System Interface) standard, for example, a logical unit corresponds to the usage region 101.

A plurality of the usage regions 101 can be allocated within one memory region 10, and each of the usage regions 101 has an independent logical address space. Though no particular limitation is imposed, a plurality of usage regions 101 may have a same address space. In this case, by specifying identification information of the usage region 101 and a logical address in the usage region 101, an address to be accessed is uniquely specified.

The unused region 102 is a region that is not assigned as the usage region 101 in the memory region 10.

The host communication unit 11 performs communication with each host 2 through the storage network 91.

The managing communication unit 12 performs communication with other storage device through the managing network 92.

The path adjusting unit 13 discriminates between whether a command and data are related to a command issued by a host 2 or by the test command issuing unit 41. When the command and the data are related to the command issued by the host 2, the path adjusting unit 13 provides a communication path between the command collecting unit 40 and the memory region 10. When the command and the data are related to the command issued by the test command issuing unit 41, the path adjusting unit 13 provides a communication path between the response time measuring unit 42 and the memory region 10.

The command collecting (acquiring) unit 40 collects (acquires) a command received from the host communication unit 11 and stores an access pattern extracted from the collected command in the pattern storage unit 50. Though no limitation is imposed, the access pattern extracted from the command is formed of a combination pattern of a command, an address, and a transfer length included in a Read/Write command or the like, for example. The command collecting unit 40 in the storage device that is a source of data transfer extracts the access pattern of the command issued to the memory region 10 of the storage device that is the source of the data transfer.

The test command issuing unit 41 issues a test command according to the access pattern stored in the pattern storage unit 50. The test command issuing unit 41 in the storage device which becomes a candidate for a destination of data transfer issues a test command.

In the storage device which becomes the candidate for the data transfer destination, the response time measuring unit 42 measures a response time (responsive) to a command issued from the test command issuing unit 41 and stores the response time in the response time storage unit 51.

In the storage device that is the source of the data transfer, a determination unit 43 determines the storage device of the data transfer destination from response times stored in the response time storage unit 51. In the response time storage unit 51 of the storage device which is the source of the data transfer, a response time measured by the storage device that is a candidate for the data transfer destination is stored.

The pattern storage unit 50 in the storage device which is the source of the data transfer stores the access pattern extracted from the command collecting unit 40.

The response time storage unit 51 of the storage device that becomes a candidate for the data transfer destination stores the response time measured by the response time measuring unit 42. On the other hand, a storage device which is the source of the data transfer receives from a storage device that is a candidate for the data transfer destination a response time measured by the storage device that is the candidate for the data transfer destination, and stores the response time in the response time storage unit 51 of the storage device which is the source of the data transfer.

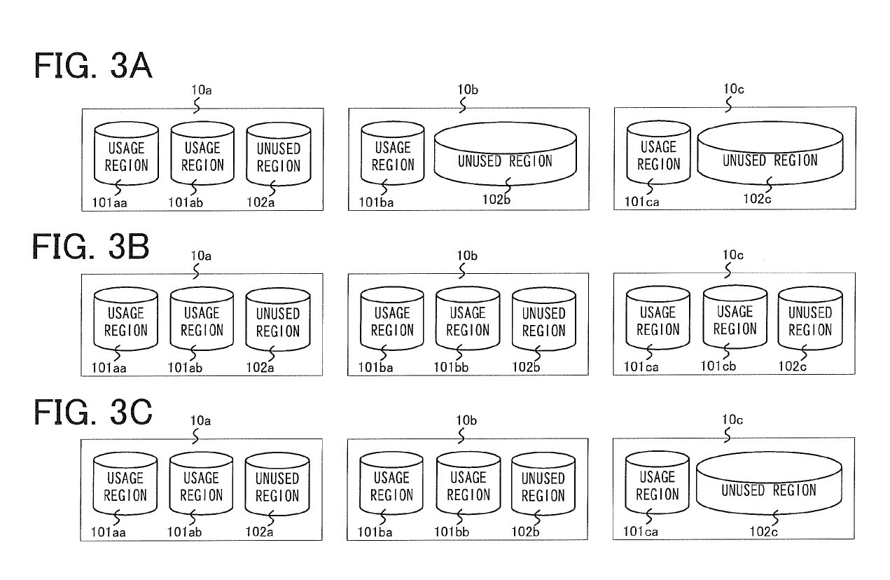

FIGS. 3A, 3B, and 3C are diagrams each showing respective states of the memory region 10 (indicated by reference numeral 10a in FIG. 3) of the storage device 1a in FIG. 2, the memory region 10 (indicated by reference numeral 10b in FIG. 3) of the storage device 1b in FIG. 2, and the memory region 10 (indicated by reference numeral 10c in FIG. 3) of the storage device 1c in FIG. 2.

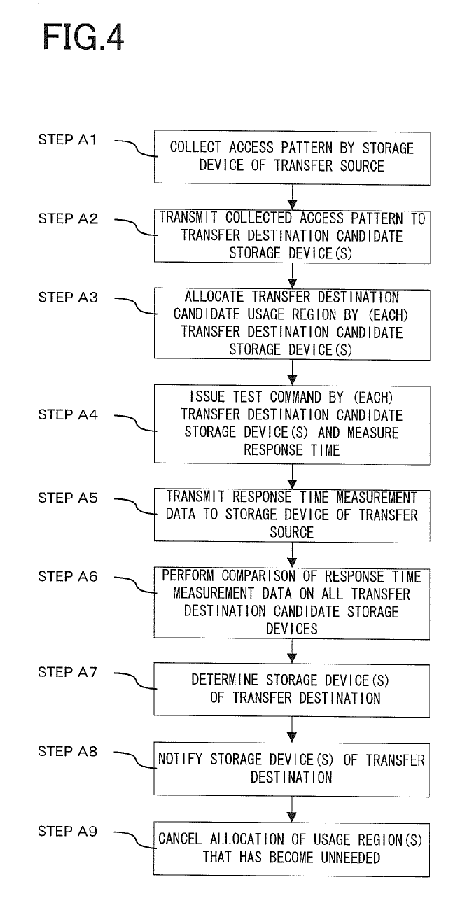

FIG. 4 is a flowchart for explaining operations of this exemplary embodiment. Next, an overall operation of this exemplary embodiment will be described in detail with reference to FIGS. 2 through 4.

A description will be given about operations in case where the respective states of the memory regions 10 of the storage devices 1a, 1b, and 1c are as shown in FIG. 3A, when a usage region 101ab of the storage device 1a is set to a transfer target, and one of the storage device 1b and the storage device 1c having better performance is selected as a storage device of a data transfer destination of the usage region 101ab, in the system in FIG. 2.

First, the command collecting unit 40 of the storage device 1a monitors a command received from a host 2. When the command is a Read command or a Write command to the usage region 101ab, the command collecting unit 40 repeats an operation of storing in the pattern storage unit 50 of the storage device 1a an instruction (command text or body), an address and a transfer length included in the command, as an access pattern (in step A1 in FIG. 4).

The command collecting unit 40 stops collecting commands after collecting the commands for a predetermined time.

The time for collecting the commands is determined according to a characteristic of an access to a usage region targeted for transfer. In the case of the system in which the access characteristic changes for each period of one day, for example, it is preferred to collect the commands during one day. In the case of a system in which the access characteristic does not greatly change at any time, the collection time may be short as far as the sufficient number of access patterns can be collected.

Next, the storage device 1a transmits the access patterns collected by the storage device 1a to each of the storage devices 1b and 1c through the managing network 92.

Each of the storage devices 1b and 1c stores the access patterns (patterns each formed of a combination of an instruction, an address and a transfer length, included in each collected command) received at each pattern storage unit 50 of the storage devices 1b and 1c (in step A2).

Next, the storage devices 1b and 1c newly perform usage area allocation so as to use a part of the unused region 102 in each of the memory regions 10 as a transfer candidate region (in step A3). The size of the logical address space of each of usage regions for which the allocation is newly performed is set to be, for example, the same as a logical address space of the usage area targeted for the transfer. The size of the logical address space of a usage region for which the allocation is newly performed, however, is not always limited to the same size. When there is an object of extending the logical address space at the same time as the data transfer, for example, allocation of a logical address space which is larger than that of the usage region targeted for the transfer may be performed.

FIG. 3B shows diagrams showing a state where the storage device 1b allocates a part of an unused region 102b (FIG. 3A) as a usage region 101bb in the memory region 10b, and the storage device 1c allocates a part of an unused region 102c (FIG. 3A) as a usage region 101cb in the memory region 10c.

Next, the test command issuing unit 41 of the storage device 1b issues test commands to the usage regions 101bb, respectively, via the response time measuring unit 42 and the path adjusting unit 13, using the access patterns stored in the pattern storage unit 50. Likewise, the test command issuing unit 41 of the storage device 1c issues the test commands to the usage regions 101cb, respectively, via the response time measuring unit 42 and the path adjusting unit 13, using the access patterns stored in the pattern storage unit 50.

Write data used when a Write command is issued as a test command may be arbitrary dummy data in accordance with a transfer length.

Data read from the usage region 101bb or the usage region 101cb respectively when each of the test command issuing unit 41 of the storage devices 1b and 1c has issued a Read command is indefinite. However, it is enough in this exemplary embodiment to measure a response time for reading out the data in accordance with a transfer length. Thus, contents of the data may be indefinite. That is, it is unnecessary to newly prepare test data for a Read in the usage region 101bb or the usage region 101cb, corresponding to a read address and the transfer length of the test command for the Read.

The response time measuring unit 42 measures a response time to each command and stores the response time in the response time storage unit 51 (in step A4).

Each of the storage devices 1b and 1c issues the commands for all the access patterns and measures response times. Then, each of the storage devices 1b and 1c transmits response time measurement data stored in the response time storage unit 51 to the storage device 1a via the managing network 92 (in step A5).

The storage device 1a stores the received response time measurement data in the response time storage unit 51.

Next, the determination unit 43 of the storage device 1a makes comparison between the response time measurement data on the storage device 1b and the response time measurement data on the storage device 1c stored in the response time storage unit 51 of the storage device 1a (in step A6), and determines a smaller summed-up value (summation) of the response times of the storage device as a storage device of the data transfer destination (in step A7).

Next, the storage device 1a notifies the storage device of the data transfer destination to the storage devices 1b and 1c (in step A8). In the storage device that does not become the storage device of the data transfer destination, the allocation of the usage region created as a transfer destination candidate is cancelled (in step A9).

FIG. 3C shows diagrams showing respective states of the memory regions 10 when the storage device 1b has been determined as the storage device of the data transfer destination.

The storage device 1c is not used as a transfer destination. Thus, allocation of the usage region 101cb (refer to FIG. 3B at 10c) secured as the candidate region of the transfer destination is cancelled to return to the initial state of unused region 102c.

The storage device 1b determined as the storage device of the data transfer destination uses the usage region 101bb as the region of the transfer destination.

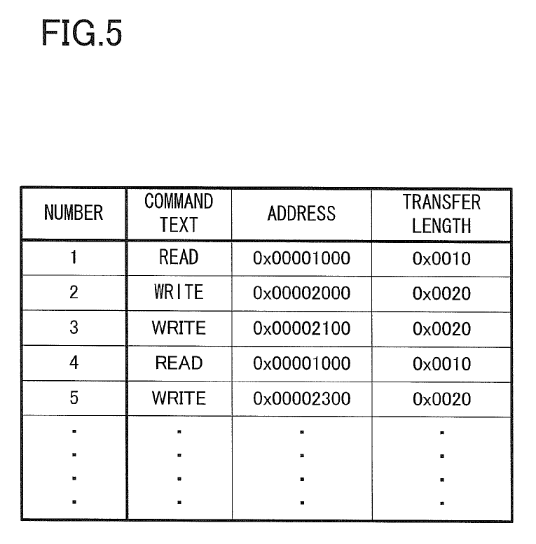

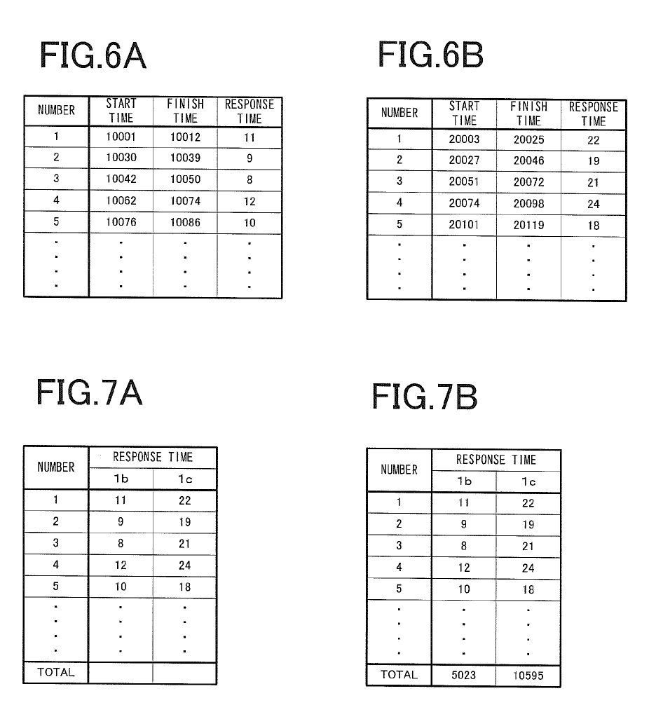

FIG. 5 is a table for explaining the operation of the exemplary embodiment of the present invention, and shows examples of the access patterns collected in step A1 in FIG. 4 and recorded in the pattern storage unit 50. FIGS. 6A and 6B are tables each showing an example of start times and finish times of test commands, and response times (responsive) to the test commands. FIGS. 7A and 7B are tables each showing an example of sums of response times of the storage devices 1b and 1c.

Referring to FIG. 5, in a number column (NUMBER), numbers added in the storage device 1a which is the source of transfer are recorded in order to identify individual commands.

In a command text column (COMMAND TEXT), a Read/Write distinction is recorded.

In an address column (ADDRESS), an address included in each command is recorded.

In a transfer length column (TRANSFER LENGTH), a transfer length included in each command is recorded. Referring to FIG. 5, the address and the transfer length are represented in hexadecimal notation.

In this embodiment, the test command issuing unit 41 in FIG. 2 creates a test command based on an access pattern (formed of an command text, an address, and a transfer length) shown in FIG. 5. That is, by inserting the command text, address, and transfer length for each entry in the pattern storage unit 50 into predetermined fields within the command (a command packet), respectively, the test command is automatically created. The insertion is performed in such a manner that the address of 0x00001000, transfer length (block) of 0x0010, and Read command text are inserted for a first test command, and the address of 0x00002000, transfer length (block) of 0x0020, and Write command text are inserted for a second test command.

FIG. 6A shows an example of a state of the response time storage unit 51 of the storage device 1b after the response times have been measured by the storage device 1b in step A4 in FIG. 4.

FIG. 6B shows an example of a state of the response time storage unit 51 of the storage device 1c after the response times are measured by the storage device 1c in step A4 in FIG. 4.

The start times and the finish times may be the ones internally held by each of the storage devices 1b and 1c. The unit of a response time computed from a difference between the start and finish times is set to be the same between the storage devices 1b and 1c.

FIG. 7A shows an example of a state of the response time storage unit 51 of the storage device 1a after the storage device 1b and the storage device 1c have transmitted the response times to the storage device 1a in step A5 in FIG. 4.

FIG. 7B shows an example of a state of the response time storage unit 51 of the storage device 1a when the determination unit 43 of the storage device 1a performs comparison of the response time measurement data in step A6 in FIG. 4.

The determination unit 43 of the storage device 1a computes a sum of the response times of the storage device 1b and a sum of the response times of the storage device 1c, respectively, and records the computed sums of the response times in the response time storage unit 51.

The determination unit 43 of the storage device 1a compares the sum of the times of the storage device 1b with the sum of the times of the storage device 1c, to determine the storage device having the smaller sum of the times as a storage device of a destination of the data transfer.

In the example in FIG. 7B, the storage device 1b has the smaller sum of the response times. Thus, the determination unit 43 of the storage device 1a determines the storage device 1b as the storage device of the data transfer destination.

In the exemplary embodiment described above, a description has been directed to an example where the sum of response times is used as an indicator for determining the storage device of a data transfer destination, and the storage device having the smaller sum of the times is determined as the storage device of the data transfer destination. The present invention is not limited to such a configuration, and according to a condition of performance needed for the storage device of the data transfer destination, other approach may be employed for the determination. For example, among the storage devices with a response time thereof to a Read command having a specific transfer length being equal to or less than a predetermined value, the storage device having a largest sum of the response times may be determined as the storage device of the data transfer destination. Alternatively, the storage device of the data transfer destination may be determined, based on a performance indicator (such as an average data transfer rate) of the storage devices derived as a result of issuance of a test command and measurement of a response time to the test command or the like. Further, depending on the derived performance indicator, it is not always necessary to measure individual response times to all test commands. Only a start time of the test command to be issued first and a finish time of the test command to be issued last may be measured and used for deriving the average transfer rate. In the exemplary embodiment described above, the description has been given about an example where after completion of the issued test command has been waited for, issuance of the next test command is performed. Depending on a request from the host or characteristics of the storage, the specific number of test commands may be successively issued without waiting for completion of the individual test commands (i.e., multiplicity of the commands may be increased).

By adapting a method of determining the storage device of the data transfer destination according to a performance requirement demanded for the storage device, a storage device most suited as a transfer destination can be selected.

A description has been directed to a configuration example where each of all the storage devices 1 includes the command collecting unit 40, test command issuing unit 41, and response time measuring unit 42, in this exemplary embodiment. A storage device 1 that is not likely to become the source of data transfer does not need the command collecting unit 40. Further, a storage device 1 that is not likely to become a data transfer destination does not need to have the test command issuing unit 41 and the response time measuring unit 42.

The storage device which is the source of data transfer does not always need to include the determination unit 43 and the response time storage unit 51 that stores all results of response times in order for the determination unit 43 to perform comparison of response time measurement data. The determination unit 43 and the response time storage unit 51 may be separately implemented by respective devices provided externally of device(s) concerned.

Next, an operation and effect of this exemplary embodiment will be described.

In this exemplary embodiment, the actual access patterns are used to measure the response times of the storage devices which are candidates for the transfer destination. Accordingly, the probability of occurrence of a situation where desired performance cannot be fulfilled for the actual access patterns after the data transfer has been completed can be reduced.

Further, in this exemplary embodiment, using the same access pattern, response time measurement is performed in a plurality of the storage devices. Thus, even when a plurality of different kinds of storage devices are present as the storage devices which are candidates for a data transfer destination, a storage device having a best performance can be selected as the storage of the data transfer destination.

In this exemplary embodiment, the test command issuing unit and the response time measuring unit are provided within each of the storage devices which are the candidates for the data transfer destination. Performance measurement of the storages which are the candidates for the transfer destination can be thereby performed without affecting traffic of the storage network.

In this exemplary embodiment, the command collecting unit is provided in the storage device of the source of the data transfer. Even when accesses to a same region targeted for the transfer are made from a plurality of the hosts, all of commands issued to the region(s) targeted for the transfer can be collected.

### Second Exemplary Embodiment

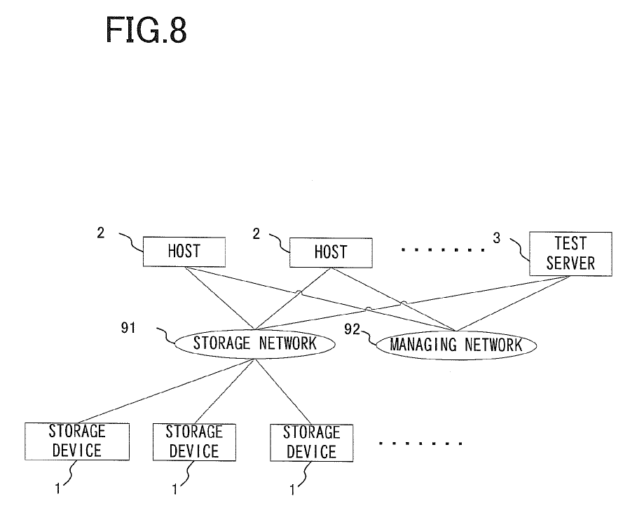

Next, a second exemplary embodiment of the present invention will be described. FIG. 8 is a diagram showing an overall system in the second exemplary embodiment of the present invention. Referring to FIG. 8, the second exemplary embodiment of the present invention includes at least one storage device 1, at least one host 2, one test server 3, a storage network 91, and a managing network 92.

The host 2 accesses the storage device 1, thereby performing data writing and data reading.

The storage device 1 records (stores) data transmitted from the host 2 and provides recorded data to the host 2, in accordance with requests (a write request and a read request) from the host 2, respectively.

The test server 3 generates a test command for the storage device 1, measures a response time, and determines a storage device of a data transfer destination.

The storage network 91 performs connection between a (each) storage device(s) 1 and a (each) host(s) 2, and performs connection between the (each) storage device(s) 1 and the test server 3, thereby providing communication paths for transmitting and receiving an access command and data.

The managing network 92 provides a communication path between the host(s) 2 and the test server 3.

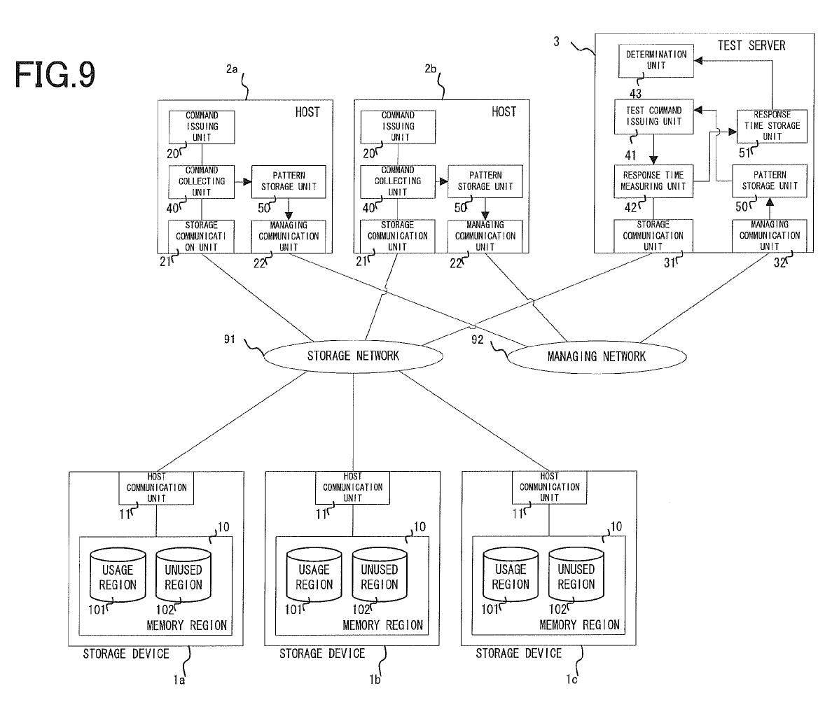

FIG. 9 is a diagram showing an example of a detailed configuration of the system in FIG. 8. In the example shown in FIG. 9, the system is formed of three storage devices 1a, 1b, and 1c as the storage devices 1 and two hosts 2a and 2b as the hosts 2.

Referring to FIG. 9, the storage device 1 in this exemplary embodiment includes a memory region 10 and a host communication unit 11.

The memory region 10 is a region formed of at least one physical memory having a physical memory address space (hereinafter referred to as a “physical address space”). The memory region 10 includes a usage region 101 and an unused region 102.

The usage region 101 is a region in which a logical address space (hereinafter referred to as a “logical address space”) is assigned to a part or entirety of the physical address space included by the memory region 10, and is a unit targeted for a Read/Write access. The logical address space does not always need to be assigned to a continuous physical address space. The logical address space may be assigned over physical address spaces of a plurality of hard disk drives by striping, such as in a RAID 0. Alternatively, a plurality of physical address spaces may be assigned to one logical address space by mirroring, such as in a RAID 1. In an SCSI (Small Computer System Interface) standard, for example, a logical unit (Logical Unit) corresponds to the usage region 101.

A plurality of the usage regions 101 can be assigned in one memory region 10, and each of the usage regions 101 has an independent logical address space. Though no limitation is imposed, the usage regions 101 may have a same address space. In this case, by specifying identification information on the usage region 101 and a logical address in the usage region 101, an address targeted for access is uniquely specified.

The unused region 102 is a region of the memory region 10 which is not assigned as the usage region 101.

The host communication unit 11 performs communication with the (each) host 2 through the storage network 91.

The host 2 (each) includes a command issuing unit 20, a storage communication unit 21, a managing communication unit 22, a command collecting unit 40, and a pattern storage unit 50.

The command issuing unit 20 generates a command for the storage unit(s) 1.

The storage communication unit 21 performs communication with each storage unit 1 through the storage network 91.

The managing communication unit 22 performs communication with the test server 3 via the managing network 92.

The command collecting unit 40 collects the command received from the command issuing unit 20 and stores in the pattern storage unit 50 an access pattern extracted from the collected command.

The pattern storage unit 50 of the host 2 stores the access pattern extracted by the command collecting unit 40.

The test server 30 includes a storage communication unit 31, a managing communication unit 32, a test command issuing unit 41, a response time measuring unit 42, a determination unit 43, a pattern storage unit 50, and a response storage unit 51.

The storage communication unit 31 performs communication with each storage unit 1 via the storage network 91.

The managing communication unit 32 performs communication with each host 2 via the managing network 92.

The test command issuing unit 41 generates a test command according to respective access pattern(s) stored in the pattern storage unit 50.

The response time measuring unit 42 measures a response time responsive to the command issued from the test command issuing unit 41, and stores the response time in the response time storage unit 51.

The determination unit 43 determines the storage device of a data transfer destination from response times stored in the response time storage unit 51.

The pattern storage unit 50 of the test server 3 stores the access pattern collected by the command collecting unit 40 of the host 2.

The response time storage unit 51 stores the response times measured by the response time measuring unit 42.

In this exemplary embodiment, one host 2 accesses a usage region 101 targeted for transfer.

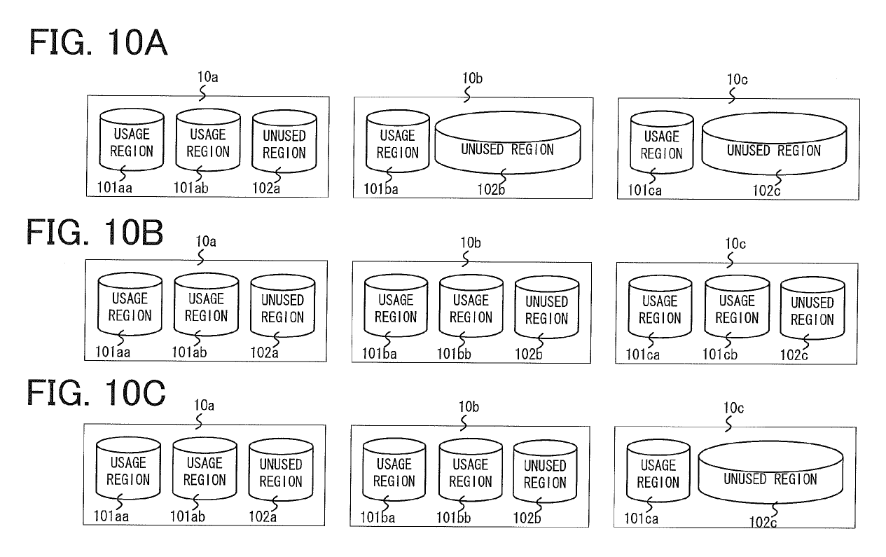

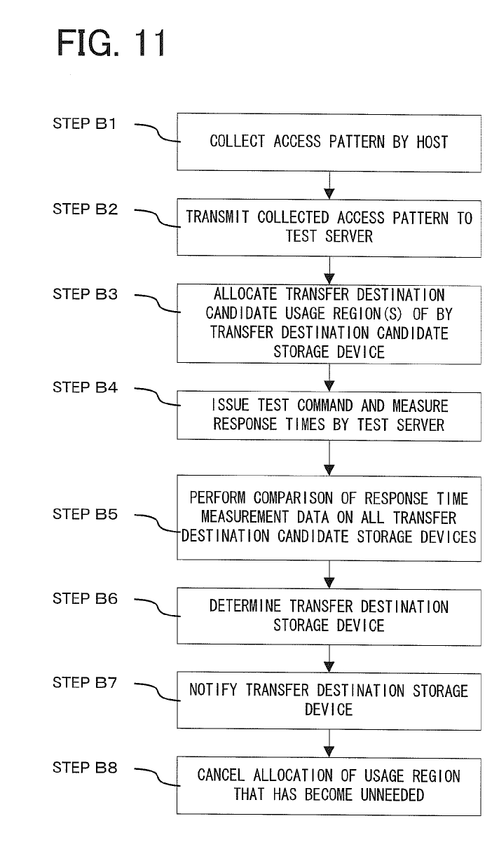

FIGS. 10A, 10B, and 10C are diagrams showing states of the memory region 10 (indicated by reference numeral 10a in FIG. 10) of the storage device 1a in FIG. 9, the memory region 10 (indicated by reference numeral 10b in FIG. 10) of the storage device 1b in FIG. 9, and the memory region 10 (indicated by reference numeral 10c in FIG. 10) of the storage device 1c in FIG. 9. FIG. 11 is a flowchart used for explaining this exemplary embodiment.

Next, an overall operation of this exemplary embodiment will be described in detail with reference to FIGS. 9 through 11.

A description will be given about operations in case where the states of the memory regions 10 of the storage devices 1a, 1b, and 1c in the system in FIG. 9 are states of the memory regions 10a, 10b, and 10c in FIG. 10A, respectively, and when one of the storage device 1b and the storage device 1c having better performance is selected as a storage device of a data transfer destination of a usage region 101ab, using the usage region 101ab of the storage device 1a as a transfer target.

Assume that the host 2 that issues a command to the usage region 101ab is set to the host 2a alone.

First, the command collecting unit 40 of the host 2a monitors the command issued by the command issuing unit 20 of the host 2a. When the command is a Read command or a Write command to the usage region 101ab, the command collecting unit 40 repeats an operation of storing the command text, an address, and a transfer length included in the command (packet) in the pattern storage unit 50 of the host 2a as an access pattern (in step B1 in FIG. 11).

After the command collecting unit 40 of the host 2a has collected commands during a predetermined period of time, the command collecting unit 40 stops collecting the commands.

The time for collecting the commands is determined according to a characteristic of an access to a usage region targeted for transfer. In the case of the system in which the access characteristic periodically changes for each period of one day, for example, it is preferred to collect the commands for one day. In the case of the system in which the access characteristic does not greatly change at any time, the collection time may be short if the sufficient number of access patterns can be collected.

Next, the host 2a transmits the collected access patterns to the test server 3 via the managing network 92. The test server 3 stores in the pattern storage unit 50 the access patterns of the host 2a received from the host 2a (in step B2).

Next, each of the storage devices 1b and 1c newly performs usage area allocation so as to use a part of the respective unused region 102 as a transfer candidate region (in step B3). The size of the logical address space of the usage region(s) for which the allocation is newly performed is set to be the same as the logical address space of the usage region targeted for the transfer, for example. The size of the logical address space of the usage region(s) for which the allocation is newly performed, however, is not always limited to the same size. When there is an object of extending the logical address space at the same time as the data transfer, for example, control may be performed so that a logical address space which is larger than that of the usage region targeted for the transfer is allocated.

FIG. 10B includes diagrams showing a state where the storage device 1b assigns a part of the unused region 102b as a usage region 101bb and the storage device 1c assigns a part of the unused region 102c (FIG. 10A) as a usage region 101cb.

Next, the test command issuing unit 41 of the test server 3 issues test commands to the usage region 101bb of the storage device 1b and the usage region 101cb of the storage device 2c via the storage network 91, using the access patterns stored in the pattern storage unit 50.

Write data used when a Write command is issued as the test command may be arbitrary dummy data in accordance with a transfer length.

Data read from the usage region 101bb or 101cb at the time a Read command is issued is indefinite (not fixed). However, in this exemplary embodiment, it suffices in this exemplary embodiment that a response time for reading out data in accordance with a transfer length can be measured. Thus, the data read from the usage region 101bb or 101cb may be indefinite.

The response time measuring unit 42 of the test server 3 measures response times responsive to the respective commands issued to the usage region 101bb and the usage region 101cb, and stores the response times in the response time storage unit 51 (in step B4).

Next, the determination unit 43 of the test server 3 makes comparison between response time measurement data on the storage device 1b and that on the storage device 1c stored in the response time storage unit 51 (in step B5). The determination unit 43 determines the storage device having a smaller summed-up value of the response times as a storage device of the data transfer destination (in step B6).

Next, the test server 3 notifies the storage device of the data transfer destination to the storage device 1a, storage device 1b, and storage device 1c (in step B7).

Based on the notification from the test server 3, allocation of the usage region created as a transfer destination candidate is cancelled in the storage device that does not become the storage device of the data transfer destination (in step B8).

FIG. 10C includes diagrams showing states of the memory regions 10 when the storage device 1b has been determined as the storage device of the data transfer destination.

The storage device 1c is not used as the transfer destination. Thus, allocation of the usage region 101cb (FIG. 10B) secured as a candidate region of the transfer destination is canceled in FIG. 10C.

The storage device 1b determined as the storage device of the data transfer destination uses the usage region 101bb as the region of the transfer destination.

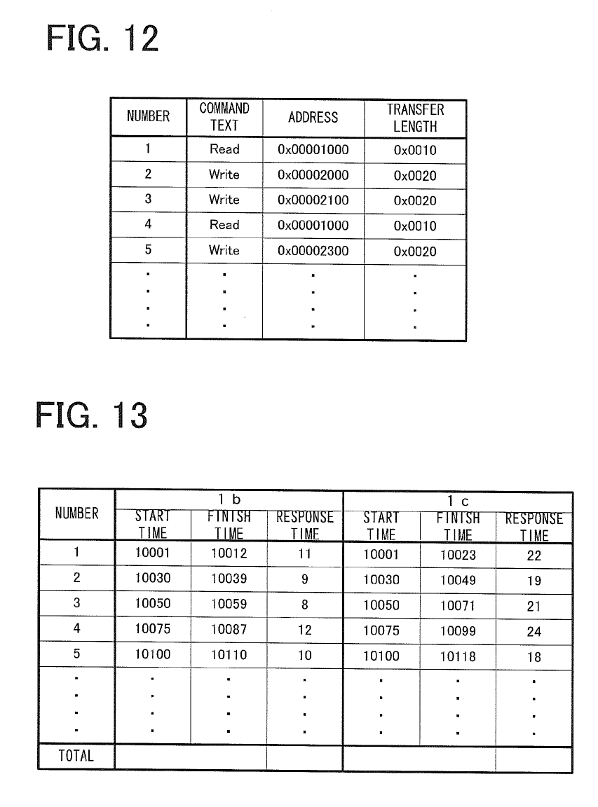

FIG. 12 shows examples of the access patterns collected and stored in the pattern storage unit 50 of the host 2a in step B1 in FIG. 11.

In a number column in FIG. 12, numbers added in the host 2a are recorded in order to identify the individual command texts.

In a command text column, a Read/Write distinction is recorded.

In an address column, an address included in each command (packet) is recorded.

In a transfer length column, a transfer length included in each commands is recorded. Incidentally, the address and the transfer length in FIG. 12 are represented in hexadecimal notation.

FIG. 13 is a diagram showing an example of a state of the response time recording unit 51 of the test server 3 in the form of a table after the response times of the storage devices 1b and 1c have been measured by the test server 3 in step B4 in FIG. 11. A start time and a finish time are those held internally by the test server 3.

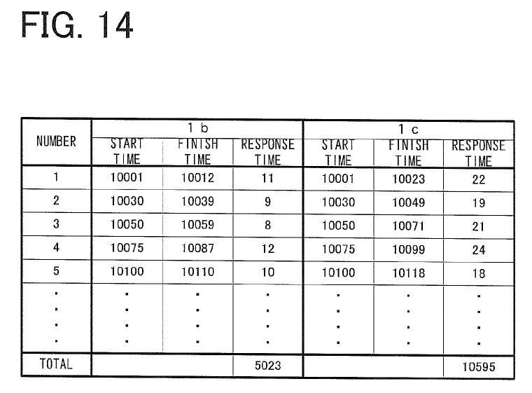

FIG. 14 is a diagram showing an example of a state of the response time recording unit 51 of the test server 3 when the determination unit 43 of the test server 3 performs comparison of the response time measurement data in step B5 in FIG. 11, in the form of a table.

The determination unit 43 of the test server 3 computes a sum of the response times of the storage device 1b and a sum of the response times of the storage device 1c, respectively, and records the computed sums in the response time recording unit 51.

The determination unit 43 of the test server 3 compares a sum of the times of the storage device 1b with a sum of the times of the storage device 1c, to determine the storage device having the smaller sum of the times as a storage device of the data transfer destination. In this exemplary embodiment, the storage device 1b has the smaller sum of the response times. Thus, the storage device 1b is determined to be the storage device of the data transfer destination.

In the above description, the storage device of the data transfer destination is determined by computing and comparing the sums of the response times. According to a condition of performance needed for the storage device of the data transfer destination, other approach may be employed for the determination.

For example, a determination method may be used in which among the storage devices each with a response time thereof to a Read command having a specific transfer length being equal to or less than a predetermined value, the storage device having a largest sum of the response times is determined as the storage device of the data transfer destination.

By adapting a method of determining the storage device of the data transfer destination according to a performance requirement demanded for the storage device, the storage device most suited as the transfer destination can be selected.

In this exemplary embodiment, a description has been directed to a configuration in which the host 2 has the command collecting unit 40 and the pattern storage unit 50. The command collecting unit 40 and the pattern storage unit 50 may be disposed in a communication path in the storage network 91 which connects the storage device 1 having the usage region 101 targeted for transfer and the host 2 that accesses the usage region 101.

Next, an operation and effect of this exemplary embodiment will be described.

In this exemplary embodiment, using the actual access patterns, measurement of the response times of the storage devices which are candidates for the transfer destination is made. Accordingly, a probability of occurrence of a situation where desired performance cannot be fulfilled for the actual access patterns after the data transfer has been completed can be reduced.

Further, in this exemplary embodiment, using the same access patterns, response time measurement is performed on a plurality of the storage devices. Thus, even when a plurality of different kinds of storage devices are present as the storage devices which are candidates for a data transfer destination, a storage device having best performance can be selected as the storage device of the data transfer destination.

Further, in this exemplary embodiment, it is not necessary to dispose the command collecting unit, test command issuing unit, response time measuring unit, response time storage unit, and pattern storage unit in each storage device as in the first exemplary embodiment. Thus, this exemplary embodiment can be introduced into an environment of a system to which existing storage devices are connected, as well.

### Third Exemplary Embodiment

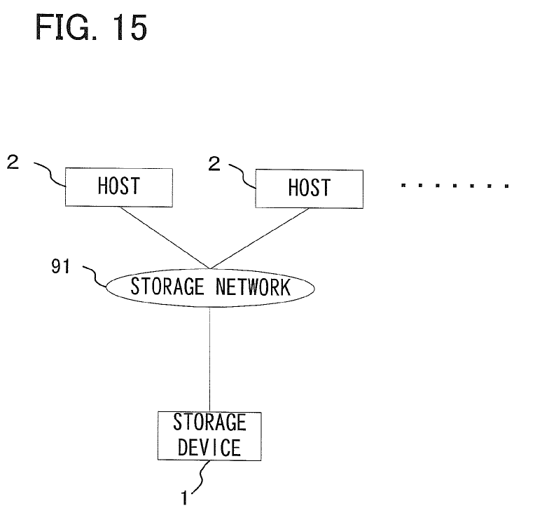

Next, a third exemplary embodiment of the present invention will be described in detail with reference to drawings. FIG. 15 is a diagram showing an overall system in the third exemplary embodiment of the present invention. Referring to FIG. 15, in this exemplary embodiment, one storage device 1 is used and the managing network 92 is deleted, which is different from the first exemplary embodiment in FIG. 1 described before.

This exemplary embodiment is useful in a case where when data in a usage region in one storage device 1 is transferred to a usage region having other physical configuration in the one storage device 1, selection is made concerning to which usage region the data is to be transferred. As such a case, transfer to a different hard disk in case a memory region is constituted from a plurality of hard disk drives, or a change in RAID redundancy level may be pointed out.

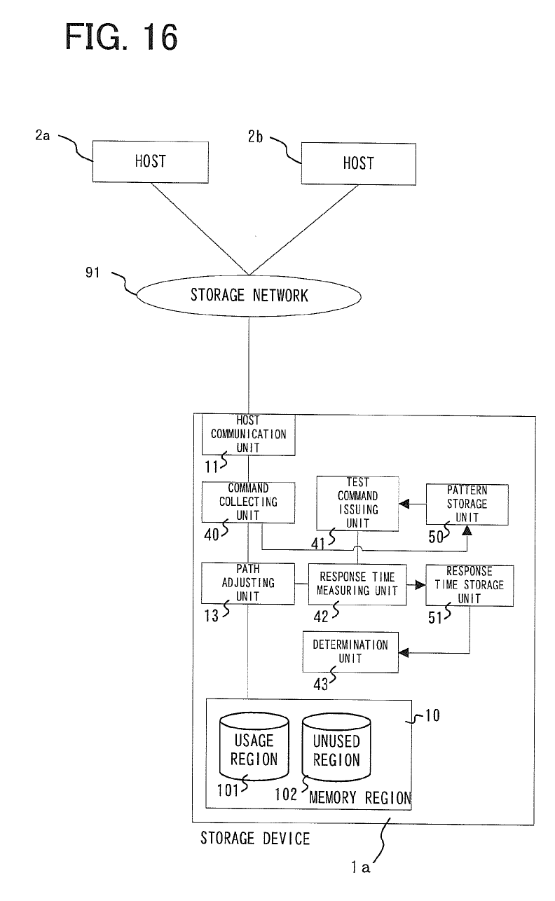

FIG. 16 is a diagram showing an example of a detailed configuration of the system in FIG. 15, and shows the example when the storage device 1 is formed of one storage device 1a and the host 2 is formed of the hosts 2a and 2b.

A configuration of the storage device 1 in this exemplary embodiment is different from that in the first exemplary embodiment in FIG. 2 in that the storage device 1 in this exemplary embodiment has no managing communication unit 12.

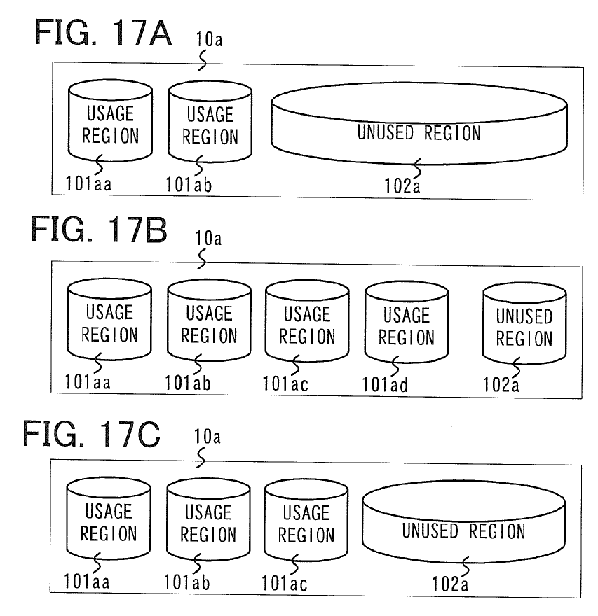

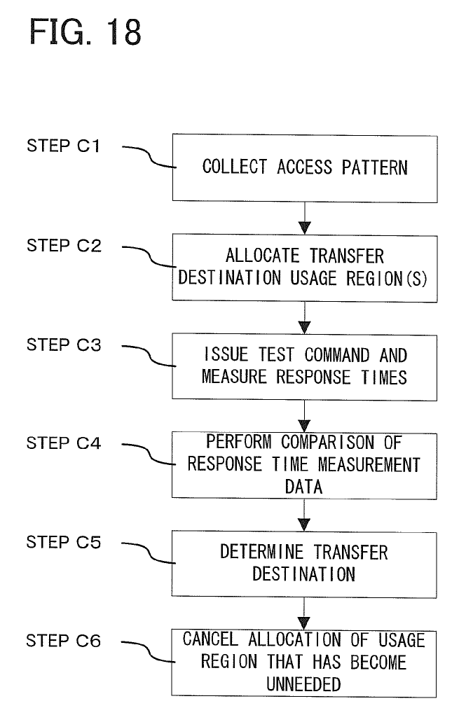

FIGS. 17A, 17B, and 17C are diagrams showing states of the memory region 10 (indicated by reference numeral 10a in FIG. 17) of the storage device 1a in FIG. 16. FIG. 18 is a flowchart for explaining operations of this exemplary embodiment.

Next, an overall operation of this exemplary embodiment will be described in detail, with reference to FIGS. 16 through 18.

A description will be given below about operations when a state of the memory region 10 of the storage device 1a is the memory region 10a in FIG. 17A, the usage region 101ab is set to a transfer target, and two transfer destination candidate regions having different physical configurations are created in the memory region 10, and one of the two transfer destination candidate regions having better performance is selected.

First, the command collecting unit 40 of the storage device 1a monitors a command received from the host 2. When the command is a Read command or a Write command to the usage region 101ab, the command collecting unit 40 repeats an operation of storing the command text, an address, and a transfer length included in the command (packet) in the pattern storage unit 50 of the storage device 1a as an access pattern (in step C1 in FIG. 18).

After collecting commands for a predetermined period of time, the command collecting unit 40 stops collecting the commands.

The time for collecting the commands is determined according to a characteristic of an access to the usage region targeted for transfer. In the case of the system in which the access characteristic changes for each period of one day, for example, it is preferred to collect the commands for one day. In the case of a system in which the access characteristic does not greatly change at any time, the collection time may be short as far as a sufficient number of access patterns can be collected.

Next, the storage device 1a newly performs usage area allocation so as to use a part of the unused region 102a as a transfer candidate region (in step C2). The size of the logical address space of a usage region for which the allocation is newly performed is set to be the same as the logical address space of the usage region targeted for the transfer, for example. The size of the logical address space of the usage region for which the allocation is newly performed, however, is not always limited to the same size. When there is an object of extending the logical address space at the same time as data transfer, for example, a logical address space which is larger than that of the usage region targeted for the transfer may be allocated.

FIG. 17B is a diagram showing a state where the storage 1a has allocated a part of the unused region 102a (FIG. 17A) as usage regions 101ac and 101ad.

Next, using the access patterns stored in the pattern storage unit 50, the test command issuing unit 41 of the storage device 1a issues test commands to the usage regions 101ac and 101ad via the response time measuring unit 42 and the path adjusting unit 13.

Write data used when a Write command is issued as the test command may be arbitrary dummy data in accordance with a transfer length. Data read from the usage region 101ac or the usage region 101ad when a Read command has been issued is indefinite. However, it suffices in this exemplary embodiment that a response time for reading out data in accordance with a transfer length can be measured. Thus, the data may be indefinite (not fixed one).

The response time measuring unit 42 measures a response time to each command, and stores the measured response time in the response time storage unit 51 (in step C3).

Next, the determination unit 43 of the storage device 1a makes comparison between certain response time measurement data on the usage region 101ac and another response time measure data on the usage region 101ad stored in the response time storage unit 51 of the storage device 1a (in step C4), and determines the usage region having a smaller sum value of response times as a transfer destination region (in step C5).

Next, the storage device 1a cancels allocation of the usage region that has not become the transfer destination region (in step C6).

FIG. 17C is a diagram showing a state of the memory region 10a where the usage region 101ac has been determined as the transfer destination region. Since the usage region 101ad in FIG. 17B is not used as a transfer destination, the allocation is cancelled to be merged with the unused region 102a.

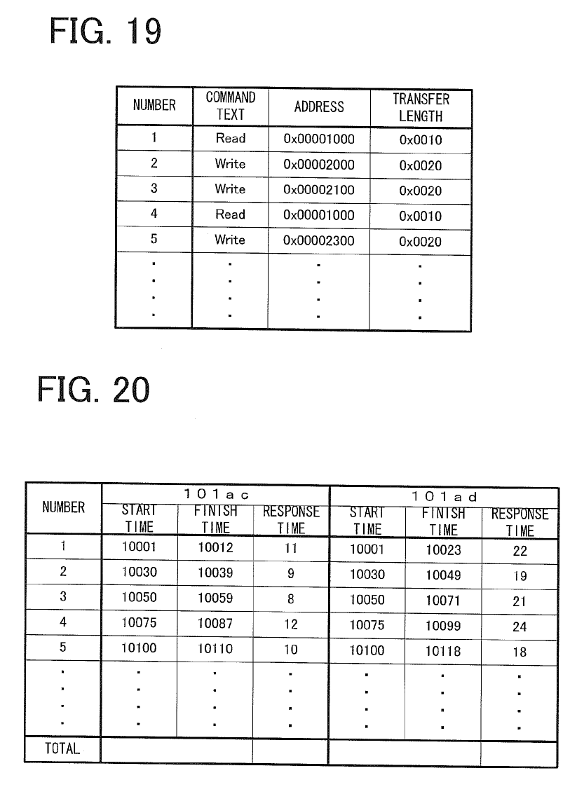

FIG. 19 is a diagram showing examples of the access patterns collected and stored in the pattern storage unit 50 in step C1 in the form of a table.

Referring to FIG. 19, in a number column, numbers added in the storage device 1a are recorded in order to identify the commands.

In a command text column, a Read/Write distinction is recorded.

In an address column, an address included in each command (packet) is recorded.

In a transfer length column, a transfer length included in each command is recorded. Incidentally, the address and the transfer length in FIG. 19 are represented in hexadecimal notation.

FIG. 20 is a diagram showing an example of a state of the response time storage unit 51 in the form of a table after the response times have been measured in step C3. A start time and a finish time are those held internally by the storage device 1a.

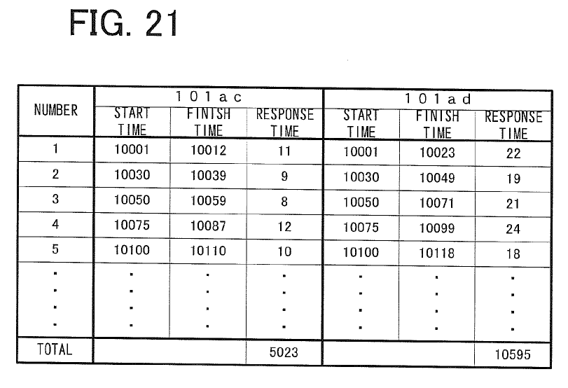

FIG. 21 is a diagram showing an example of a state of the response time recording unit 51 of the storage device 1a when the determination unit 43 of the storage device 1a performs comparison of the response time measurement data in step C4, in the form of a table.

This exemplary embodiment will be described with reference to FIGS. 19 through 21.

The determination unit 43 of the storage device 1a computes a sum of the response times of the usage region 101ac and a sum of the response times of the usage region 101ad, respectively, and records the computed sums in the response time recording unit 51. The determination unit 43 of the storage device 1a compares the sum of the times of the usage region 101ac with the sum of the times of the usage region 101ad and determines the storage device having a smaller sum of the times as the storage device of the data transfer destination.

In this exemplary embodiment, the usage region 101ac has the smaller sum of the response times. Thus, the determination unit 43 of the storage device 1a determines the usage region 101ac as the storage device of the data transfer destination.

In the above description, the memory region of the transfer destination is determined by computing and comparing the sums of the response times. According to a condition of performance needed for the memory region of the transfer destination, other approach may be employed for the determination. For example, a determination method may be used in which among the usage regions each with a response time thereof to a Read command having a specific transfer length being equal to or less than a predetermined value, the usage region having a largest sum of the response times is determined as the memory region of the transfer destination.

By adapting a method of determining the memory region of the data transfer destination according to a performance requirement demanded for the memory region of the data transfer destination, the memory region most suited as the destination of the data transfer can be selected.

Next, an operation and effect of this exemplary embodiment will be described.

In this exemplary embodiment, using the actual access patterns, measurement of the response times is made in the memory regions which are the transfer destination candidates. Accordingly, a possibility of occurrence of a situation where desired performance cannot be fulfilled for the actual access patterns after the data transfer has been completed can be reduced.

Further, in this exemplary embodiment, using the same access patterns, response time measurement is performed on the transfer destination candidate memory regions. Thus, even when a plurality of regions having different physical configurations are created as transfer destination candidate memory regions, a memory region having a best performance can be selected as the memory region of a transfer destination.

The present invention can be applied to a use such as a means for determining a storage device that becomes a data transfer destination from among a plurality of storage devices. Further, the present invention can be applied to a use as well where inside a storage device, a physical configuration of a memory region is determined upon performing data rearrangement.

In each of the exemplary embodiments described before, the test commands in the form of reproduction of access commands (Read/Write commands) collected during a most recent command collection period for the memory region which is the source of the data transfer are applied to the memory regions which are the data transfer destination candidates. The present invention, however, is not limited to such a configuration alone. It suffices that a test command which reflects a load of an access that has been actually made or will be made can be created for the memory regions of the data transfer destination candidates. That is, as access patterns, in addition to the access patterns collected from the access commands collected during the most recent command collection period, access patterns extracted from commands collected earlier than the most recent command collection period may be used.

The above description of the present invention has been given in connection with the exemplary embodiments described above. The present invention, however, is not limited to configurations of the exemplary embodiments described above, and of course includes various variations and modifications that could be made by those skilled in the art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A storage system comprising:
a plurality of memory regions;
a command collecting unit that collects a command to be received by at least one of the memory regions and extracts access information of the command from the collected command;
a test command issuing unit that issues a test command to any other ones of the memory regions than said at least one of the memory regions with the command thereto collected by said command collecting unit, the test command having the extracted access information as contents thereof; and
a response time measuring unit that measures a response time to the test command issued from said test command issuing unit to any other ones of said memory regions.

2. A storage system comprising:
first and second storage devices each including at least one memory region;
said first storage device including:
a command collecting unit that collects a command to be received by the at least one memory region of said first storage device and extracts access information of the command from the collected command;
said second storage device including:
a test command issuing unit that receives the access information extracted by said command collecting unit of said first storage device and issues a test command having the access information as contents thereof; and
a response time measuring unit that measures a response time to the test command issued from said test command issuing unit to the at least one memory region of said second storage device.

3. The storage system according to claim 1, wherein the storage system includes at least one storage device having the memory regions; and
said test command issuing unit is provided externally of said at least one storage device.

4. The storage system according to claim 1, wherein the storage system includes at least one storage device having the memory regions; and
said test command issuing unit and said response time measuring unit are provided outside said at least one storage device.

5. The storage system according to claim 1, wherein the storage system includes a host that issues a command to any ones of the memory regions; and
said host includes said command collecting unit.

6. The storage system according to claim 1, wherein the storage system includes:
a storage device having the memory regions;
a host that issues the command to each of the memory regions; and
a communication path that connects said storage device and said host;
said command collecting unit being disposed on said communication path.

7. The storage system according to claim 1, comprising:
at least one storage device having the memory regions;
said at least one storage device including:
said command collecting unit;
said test command issuing unit; and
said response time measuring unit.

8. The storage system according to claim 1, comprising:
a determination unit that determines one of the memory regions of a switching-over destination, based on results of measurement of the response times to the test command.

9. The storage system according to claim 8, wherein said determination unit sums up response times responsive to a plurality of the test commands measured by said response time measuring unit and determines one of the memory regions based on the sum of the response times satisfying a predetermined condition, as the memory region of the switching-over destination.

10. The storage system according to claim 1, wherein the access information includes a command text, an address of said at least one of the memory regions, and a transfer length, contained in the command.

11. The storage system according to claim 1, comprising:
a storage device including the memory regions;
a host that issues the command to each of the memory regions of said storage device; and
a server that communicates with said storage device and said host;
said host including said command collecting unit; and
said server including said test command issuing unit and said response time measuring unit.

12. A system including:
a plurality of memory regions;
means for issuing a test command to a candidate memory region based on history information on a data access command already issued to an other one of the memory regions when selecting one of the memory regions used for a data access, the test command reflecting the data access actually made to said other one of the memory regions; and
means for determining said one of the memory regions based on a performance characteristic of said candidate memory region measured in association with execution of the test command.

13. A storage system including:
a plurality of memory regions;
means for issuing a test command associated with a command already issued to any one of the memory regions to any other ones of the memory regions; and
means for measuring responses to the test command for said other ones of the memory regions and determining one of the memory regions of a switching-over destination, based on results of measurement.

14. A method of selecting a memory region in a storage system having a plurality of memory regions, said method comprising:
collecting a command to be received by at least one of the memory regions and extracting access information from the collected command;
issuing a test command to any other ones of the memory regions than said at least one of the memory regions for which the command thereto has been collected, the test command having the extracted access information as contents thereof;
measuring response times to the test command issued to the other memory regions; and
selecting one memory region from the other memory regions based on results of measurement of the response times.

15. A method of selecting a memory region, comprising:
issuing a test command to a candidate memory region based on history information on a data access command already issued to an other one of memory regions when selecting one of the memory regions used for a data access, the test command reflecting the data access actually made to the other memory region; and
selecting said one of the memory regions based on a performance characteristic of the candidate memory region measured in association with execution of the test command.

16. A program that causes a computer to execute processing of selecting a memory region from a storage system including a plurality of memory regions, the processing comprising:
collecting a command to be received by at least one of the memory regions and extracting access information from the collected command;
issuing a test command to any other ones of the memory regions than the at least one of the memory regions with the command thereto collected, the test command having the extracted access information as contents thereof;
measuring response times to the test command issued to the other memory regions; and
selecting the memory region based on results of measurement of the response times.

17. A program that causes a computer to execute processing of:
issuing a test command to a candidate memory region based on history information on a data access command already issued to any other ones of memory regions when selecting one of the memory regions used for a data access, the test command reflecting the data access actually made to the other ones of the memory regions; and
selecting said one of the memory regions based on a performance characteristic of the candidate memory region measured in association with execution of the test command.
